(19) United States
(12) Patent Application Publication
(10) Pub. No.: US 2024/0217836 A1
(43) Pub. Date: Jul. 4, 2024

(54) NEGATIVE ELECTRODE MATERIAL FOR LITHIUM SECONDARY BATTERY, AND METHOD FOR PRODUCING SAME

(71) Applicant: INDUSTRY-UNIVERSITY COOPERATION FOUNDATION HANYANG UNIVERSITY ERICA CAMPUS, Ansan-si (KR)

(72) Inventors: Jin Ho Bang, Ansan-si (KR); Hansol Lim, Ansan-si (KR); Muhammad Awais Abbas, Ansan-si (KR)

(73) Assignee: INDUSTRY-UNIVERSITY COOPERATION FOUNDATION HANYANG UNIVERSITY ERICA CAMPUS, Ansan-si (KR)

(21) Appl. No.: 18/419,668

(22) Filed: Jan. 23, 2024

Related U.S. Application Data
(63) Continuation of application No. PCT/KR2022/011779, filed on Aug. 8, 2022.

(30) Foreign Application Priority Data
Aug. 26, 2021 (KR) 10-2021-0113240
May 16, 2022 (KR) 10-2022-0059787

(51) Int. Cl. C01G 23/00; H01M 4/485

(52) U.S. Cl. CPC C01G 23/005; H01M 4/485; C01P 2002/72; C01P 2002/78; C01P 2002/82; C01P 2002/85; C01P 2004/03; C01P 2004/04; C01P 2006/12; C01P 2006/14; C01P 2006/16; C01P 2006/40

(57) ABSTRACT

Provided is a method for producing a negative electrode material for a lithium secondary battery. The method for producing a negative electrode material for a lithium secondary battery may comprise the steps of: preparing a base structure including lithium-titanium-oxide (Li₄Ti₅O₁₂, LTO); improving the electrical conductivity and lithium ion conductivity of the base structure by primarily heat treating the base structure; and eliminating oxygen vacancies present in the primarily heat-treated base structure by secondarily heat treating the primarily heat-treated base structure.

### CROSS REFERENCE TO RELATED APPLICATIONS

This is a continuation of International Patent Application PCT/KR2022/011779 (filed 8 Aug. 2022), which claims the benefit of Republic of Korea Patent Application KR 10-2021-0113240 (filed 26 Aug. 2021) and Republic of Korea Patent Application KR 10-2022-0059787 (filed 16 May 2022). The entire disclosure of each of these priority applications is hereby incorporated by reference herein.

### TECHNICAL FIELD

The present invention relates to a negative electrode material for a lithium secondary battery and a method for producing the same, and more particularly, to a negative electrode material for a lithium secondary battery, which includes lithium-titanium-oxide (Li₄Ti₅O₁₂, LTO), and a method for producing the same.

The present disclosure has been derived as a result of the following research and development project.
Related research project: Development of water electrolysis system technology for producing solar conversion hydrogen (Ansan City)
Research project identification number: GRRCHanyang2020-A01 (202100100010001)
Business competent Ministry: Local government
Research business name: Gyeonggi regional research center business (GRRC)/Gyeonggi regional research center business (GRRC)/GRRC basic project
Lead organization: Gyeonggi regional research center
Research management specialized organization: Gyeonggi provincial office
Research period: Jul. 1, 2021-Jun. 30, 2022

### BACKGROUND ART

It is known that a lithium secondary battery does not exhibit a memory effect (an effect of decreasing an overall capacity as charging and discharging are repeatedly performed) exhibited in a nickel-cadmium battery and a nickel-metal hydride battery, which are conventionally used.

However, according to a recent research result, it was found that a lithium secondary battery in which a specific material such as lithium iron phosphate (LiFePO₄), anatase TiO₂, or lithium-titanium-oxide (Li₄Ti₅O₁₂, LTO) doped with aluminum (Al) is used also exhibits the memory effect.

The memory effect exhibited in the lithium secondary battery has been understood based on a thermodynamic viewpoint through a particle-by-particle model. In particular, it was found that aluminum ions move similarly to movements of lithium ions in the lithium-titanium-oxide (Li₄Ti₅O₁₂, LTO) doped with aluminum, which is an irreversible reaction, so that the movements of the lithium ions may be interfered with, resulting in the memory effect.

The lithium-titanium-oxide (Li₄Ti₅O₁₂, LTO) has an advantage of great stability within an operating voltage so as to be spotlighted as a negative electrode material for a lithium secondary battery, whereas the lithium-titanium-oxide has a disadvantage of a low electric conductivity and a low lithium ion conductivity. Accordingly, attempts have been made to improve electric conductivity and lithium ion conductivity through a method of doping lithium-titanium-oxide (Li₄Ti₅O₁₂, LTO) with aluminum (Al) or the like, but another problem that the memory effect occurs as described above has arisen.

For this reason, various research is being conducted on a method for improving electric conductivity and lithium ion conductivity and reducing a memory effect while maintaining an advantage of lithium-titanium-oxide (Li₄Ti₅O₁₂, LTO).

### DISCLOSURE

### Technical Problem

One technical object of the present invention is to provide a negative electrode material for a lithium secondary battery and a method for producing the same, capable of improving electric conductivity.

Another technical object of the present invention is to provide a negative electrode material for a lithium secondary battery and a method for producing the same, capable of improving lithium ion conductivity.

Still, another technical object of the present invention is to provide a negative electrode material for a lithium secondary battery and a method for producing the same, capable of using LTO that is not doped with aluminum.

Yet another technical object of the present invention is to provide a negative electrode material for a lithium secondary battery and a method for producing the same, capable of reducing a memory effect.

Technical objects of the present invention are not limited to the above-described technical objects.

### Technical Solution

In order to achieve the technical objectives described above, according to the present invention, there is provided a method for producing a negative electrode material for a lithium secondary battery.

According to one embodiment, the method for producing the negative electrode material for the lithium secondary battery includes: preparing a base structure including lithium-titanium-oxide (Li₄Ti₅O₁₂, LTO); improving electric conductivity and lithium ion conductivity of the base structure by primarily heat-treating the base structure; and eliminating an oxygen vacancy present in the primarily heat-treated base structure by secondarily heat-treating the primarily heat-treated base structure.

According to one embodiment, a primary heat treatment environment of the base structure and a secondary heat treatment environment of the base structure may be different from each other.

According to one embodiment, the primary heat treatment of the base structure may be performed in an air atmosphere, and the secondary heat treatment of the base structure may be performed in an oxygen (O₂) atmosphere.

According to one embodiment, an oxygen vacancy content in the primarily heat-treated base structure may be greater than an oxygen vacancy content in the base structure before the heat treatment, and an oxygen vacancy content in the secondarily heat-treated base structure may be less than the oxygen vacancy content in the base structure before the heat treatment.

According to one embodiment, a primary heat treatment temperature and a primary heat treatment time of the base structure may be identical to a secondary heat treatment temperature and a secondary heat treatment time of the base structure, respectively.

According to one embodiment, the primary heat treatment and the secondary heat treatment of the base structure may be performed at a temperature of 780° C. for 5 hours.

According to one embodiment, an inter-lattice distance (d-spacing) of a surface of the base structure before the heat treatment may be shorter than an inter-lattice distance of a surface of the primarily heat-treated base structure, and an inter-lattice distance of a surface of the secondarily heat-treated base structure may be shorter than the inter-lattice distance of the surface of the base structure before the heat treatment.

According to one embodiment, the secondary heat treatment of the base structure may be performed while supplying oxygen (O₂) at a flow rate of 0.5 L/min.

In order to achieve the technical objectives described above, according to the present invention, there is provided a negative electrode material for a lithium secondary battery.

According to one embodiment, the negative electrode material for the lithium secondary battery includes lithium-titanium-oxide (Li₄Ti₅O₁₂, LTO), wherein, as a result of X-ray photoelectron spectroscopy (XPS) analysis of the lithium-titanium-oxide, an area ratio (area %) of an oxygen vacancy is less than or equal to 9.38%.

According to one embodiment, the lithium-titanium-oxide may not be doped with a metal.

According to one embodiment, the metal may include aluminum (Al).

According to one embodiment, an average inter-lattice distance (d-spacing) of a center portion of the lithium-titanium-oxide may be equal to an average inter-lattice distance of a surface portion of the lithium-titanium-oxide.

### Advantageous Effects

According to an embodiment of the present invention, a method for producing a negative electrode material for a lithium secondary battery may include: preparing a base structure including lithium-titanium-oxide (Li₄Ti₅O₁₂, LTO); improving an electric conductivity and a lithium ion conductivity of the base structure by primarily heat-treating the base structure in an air atmosphere; and eliminating an oxygen vacancy present in the primarily heat-treated base structure by secondarily heat-treating the primarily heat-treated base structure in an oxygen (O₂) atmosphere. Accordingly, even without doping the lithium-titanium-oxide (Li₄Ti₅O₁₂, LTO) with a metal (e.g., aluminum), the electric conductivity and the lithium ion conductivity can be improved, and occurrence of a memory effect caused by the oxygen vacancy can also be reduced.

### DESCRIPTION OF DRAWINGS

FIG. 1 is a flowchart describing a method for producing a negative electrode material for a lithium secondary battery according to an embodiment of the present invention.

FIG. 2 is an SEM image of a negative electrode material for a lithium secondary battery according to an experimental example of the present invention.

FIGS. 3 to 5 show XRD analysis results of the negative electrode material for the lithium secondary battery according to the experimental example of the present invention.

FIG. 6 shows a Raman analysis result of the negative electrode material for the lithium secondary battery according to the experimental example of the present invention.

FIG. 7 is a view for describing a surface area of the negative electrode material for the lithium secondary battery according to the experimental example of the present invention.

FIG. 8 is a TEM image of the negative electrode material for the lithium secondary battery according to the experimental example of the present invention.

FIGS. 9 and 10 show XPS analysis results of the negative electrode material for the lithium secondary battery according to the experimental example of the present invention.

FIG. 11 is a view for describing an inter-lattice distance of the negative electrode material for the lithium secondary battery according to the experimental example of the present invention.

FIGS. 12 to 14 are views for describing galvanostatic charge/discharge analysis results of a lithium secondary battery according to an experimental example of the present invention.

FIGS. 15 to 17 are views for describing EIS analysis results of the lithium secondary battery according to the experimental example of the present invention.

### MODE FOR INVENTION

Hereinafter, exemplary embodiments of the present invention will be described in detail with reference to the accompanying drawings. However, the technical idea of the present invention is not limited to the embodiments described herein, but may be realized in different forms. The embodiments introduced herein are provided to sufficiently deliver the idea of the present invention to those skilled in the art so that the disclosed contents may become thorough and complete.

When it is mentioned in the present disclosure that one element is on another element, it means that one element may be directly formed on another element, or a third element may be interposed between one element and another element. Further, in the drawings, thicknesses of films and regions are exaggerated for effective description of the technical contents.

In addition, in various embodiments of the present disclosure, the terms such as first, second, and third are used to describe various elements, but the elements are not limited by the terms. The terms are used only to distinguish one element from another element. Therefore, an element mentioned as a first element in one embodiment may be mentioned as a second element in another embodiment. The embodiments described and illustrated herein include their complementary embodiments. Further, the term “and/or” used herein is used to include at least one of the elements enumerated before and after the term.

As used herein, an expression in a singular form includes a meaning of a plural form unless the context clearly indicates otherwise. Further, the terms such as “including” and “having” are intended to designate the presence of features, numbers, steps, elements, or combinations thereof described in the present disclosure, and shall not be construed to preclude any possibility of the presence or addition of one or more other features, numbers, steps, elements, or combinations thereof. In addition, the term “connection” used herein is used to include both indirect and direct connections of a plurality of elements.

Further, in the following description of the present invention, detailed descriptions of known functions or configurations incorporated herein will be omitted when they may make the gist of the present invention unnecessarily unclear.

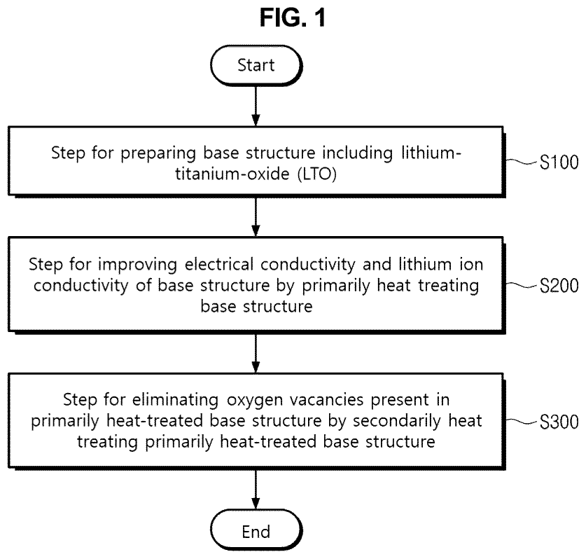

FIG. 1 is a flowchart describing a method for producing a negative electrode material for a lithium secondary battery according to an embodiment of the present invention.

Referring to FIG. 1, a base structure including lithium-titanium-oxide (Li₄Ti₅O₁₂, LTO) may be prepared (S100). According to one embodiment, an average inter-lattice distance (d-spacing) of a center portion of the base structure may be equal to an average inter-lattice distance of a surface portion of the base structure. In detail, each of the average inter-lattice distances of the center portion of the base structure and the average inter-lattice distance of the surface portion of the base structure may be 4.73 nm.

The base structure may be primarily heat-treated (S200). According to one embodiment, the primary heat treatment of the base structure may be performed at a temperature of 780° C. for 5 hours in an air atmosphere.

When the base structure is primarily heat-treated, the electric conductivity and lithium ion conductivity of the base structure may be improved. However, as the base structure is primarily heat-treated, an oxygen vacancy may be formed within the base structure. In other words, an oxygen vacancy content in the primarily heat-treated base structure may be greater than an oxygen vacancy content in the base structure before the heat treatment. In detail, as a result of X-ray photoelectron spectroscopy (XPS) analysis of the base structure before the heat treatment, an area ratio (area %) of an oxygen vacancy may be 12.96%, and as a result of X-ray photoelectron spectroscopy (XPS) analysis of the primarily heat-treated base structure, an area ratio (area %) of an oxygen vacancy may be 26.14%.

Since the base structure is primarily heat-treated to form the oxygen vacancy, an average inter-lattice distance of a center portion of the primarily heat-treated base structure and an average inter-lattice distance of a surface portion of the primarily heat-treated base structure may become different from each other. In detail, while the average inter-lattice distance of the center portion of the primarily heat-treated base structure is 4.73 nm, which is equal to the average inter-lattice distance of a state before the heat treatment, the average inter-lattice distance of the surface portion of the primarily heat-treated base structure is 5.12 nm, which may be greater than the average inter-lattice distance of the state before the heat treatment. In other words, an average inter-lattice distance (d-spacing) of a surface of the base structure before the heat treatment may be shorter than an average inter-lattice distance of a surface of the primarily heat-treated base structure.

The oxygen vacancy formed within the base structure may cause a memory effect (an effect of decreasing an overall capacity as charging and discharging are repeatedly performed) of a lithium secondary battery.

After the base structure is primarily heat-treated, the base structure may be secondarily heat-treated (S300). According to one embodiment, the secondary heat treatment of the base structure may be performed at a temperature of 780° C. for 5 hours in an oxygen (O₂) atmosphere. In more detail, the base structure may be secondarily heat-treated by placing the base structure in a tube and heat-treating the base structure while supplying oxygen (O₂) at a flow rate of 0.5 L/min. In other words, the secondary heat treatment of the base structure may be performed in an oxygen (O₂) atmosphere with a relatively high concentration as compared with the primary heat treatment of the base structure.

When the base structure is secondarily heat-treated, oxygen vacancies formed during the primary heat treatment of the base structure may be eliminated. According to one embodiment, an oxygen vacancy content in the secondarily heat-treated base structure may be less than the oxygen vacancy content in the base structure before the heat treatment. In detail, as a result of X-ray photoelectron spectroscopy (XPS) analysis of the secondarily heat-treated base structure, an area ratio (area %) of an oxygen vacancy may be 9.38%.

According to one embodiment, average inter-lattice distances of a center portion and a surface portion of the secondarily heat-treated base structure may be shorter than average inter-lattice distances of the center portion and the surface portion of the primarily heat-treated base structure. In addition, the average inter-lattice distances of a center portion and a surface portion of the secondarily heat-treated base structure may be equal to each other. In detail, each of the average inter-lattice distances of a center portion and a surface portion of the secondarily heat-treated base structure may be 2.93 nm.

According to one embodiment, a concentration of an oxygen vacancy present in the surface portion of the secondarily heat-treated base structure may be lower than a concentration of an oxygen vacancy present in a region of the secondarily heat-treated base structure, which is located from the surface portion toward the center portion. The concentration of the oxygen vacancy may be defined as the number of oxygen vacancies per area (or volume).

Since the oxygen vacancy in the base structure is eliminated through the secondary heat treatment, the memory effect of the lithium secondary battery may be reduced. For this reason, when the secondarily heat-treated base structure is used as a negative electrode material for a lithium secondary battery, the electric conductivity and lithium ion conductivity of the lithium secondary battery may be improved, and the memory effect may also be reduced.

As a result, according to an embodiment of the present invention, a method for producing a negative electrode material for a lithium secondary battery may include: preparing a base structure including lithium-titanium-oxide (Li₄Ti₅O₁₂, LTO); improving an electric conductivity and a lithium ion conductivity of the base structure by primarily heat-treating the base structure in an air atmosphere; and eliminating an oxygen vacancy present in the primarily heat-treated base structure by secondarily heat-treating the primarily heat-treated base structure in an oxygen (O₂) atmosphere. Accordingly, even without doping the lithium-titanium-oxide (Li₄Ti₅O₁₂, LTO) with a metal (e.g., aluminum), the electric conductivity and the lithium ion conductivity may be improved, and occurrence of a memory effect caused by the oxygen vacancy may also be reduced.

Accordingly, the method for producing the negative electrode material for the lithium secondary battery according to the embodiment of the present invention has been described above. Hereinafter, a method for producing a negative electrode material for a lithium secondary battery according to modified examples of the present invention will be described.

### Method for Producing Negative Electrode Material for Lithium Secondary Battery According to First Modified Example

Similar to the method for producing the negative electrode material for the lithium secondary battery according to the embodiment described above, a method for producing a negative electrode material for a lithium secondary battery according to a first modified example of the present invention may include: preparing a base structure including lithium-titanium-oxide (Li₄Ti₅O₁₂, LTO); improving an electric conductivity and a lithium ion conductivity of the base structure by primarily heat-treating the base structure; and eliminating an oxygen vacancy present in the primarily heat-treated base structure by secondarily heat-treating the primarily heat-treated base structure. However, the method for producing the negative electrode material for the lithium secondary battery according to the first modified example may have a different tube used in the process of secondarily heat-treating the base structure as compared with the method for producing the negative electrode material for the lithium secondary battery according to the embodiment described above.

In detail, according to the method for producing the negative electrode material for the lithium secondary battery according to the embodiment described above, a tube in which sizes of an oxygen (O₂) inlet and an oxygen (O₂) outlet are equal to each other may be used in the process of secondarily heat-treating the base structure. Meanwhile, according to the method for producing the negative electrode material for the lithium secondary battery according to the first modified example, a tube in which sizes of an oxygen (O₂) inlet and an oxygen (O₂) outlet are different from each other may be used in the process of secondarily heat-treating the base structure.

For example, the tube used in the process of secondarily heat-treating the base structure according to the first modified example may be configured such that the size of the outlet is smaller than the size of the inlet. In other words, a diameter of the tube used in the process of secondarily heat-treating the base structure according to the first modified example may gradually become smaller from the inlet to the outlet. For this reason, sufficient oxygen (O₂) may be supplied to a base structure that is adjacent to the outlet. Meanwhile, when a tube in which an inlet and an outlet have the same size or a tube in which a size of an outlet is greater than a size of an inlet is used, sufficient oxygen (O₂) may not be supplied to the base structure that is adjacent to the outlet. Accordingly, the oxygen vacancy may not be eliminated in the base structure that is adjacent to the outlet.

However, as described above, when the secondary heat treatment is performed through the tube having the diameter that gradually becomes smaller from the inlet to the outlet, sufficient oxygen (O₂) may be supplied on the whole regardless of a position of the base structure disposed inside the tube, so that oxygen vacancies of all base structures may be easily eliminated.

According to one embodiment, the tube used in the process of secondarily heat-treating the base structure according to the first modified example may have a flat bottom surface. Accordingly, the base structure disposed in the tube may be prevented from being biased to one side.

### Method for Producing Negative Electrode Material for Lithium Secondary Battery According to Second Modified Example

Similar to the method for producing the negative electrode material for the lithium secondary battery according to the embodiment described above, a method for producing a negative electrode material for a lithium secondary battery according to a second modified example of the present invention may include: preparing a base structure including lithium-titanium-oxide (Li₄Ti₅O₁₂, LTO); improving an electric conductivity and a lithium ion conductivity of the base structure by primarily heat-treating the base structure; and eliminating an oxygen vacancy present in the primarily heat-treated base structure by secondarily heat-treating the primarily heat-treated base structure. However, the method for producing the negative electrode material for the lithium secondary battery according to the second modified example may have a different flow rate of oxygen (O₂) supplied during the process of secondarily heat-treating the base structure as compared with the method for producing the negative electrode material for the lithium secondary battery according to the embodiment described above.

In detail, according to the method for producing the negative electrode material for the lithium secondary battery according to the embodiment described above, a flow rate of oxygen (O₂) supplied during the process of secondarily heat-treating the base structure may be maintained constant. Meanwhile, according to the method for producing the negative electrode material for the lithium secondary battery according to the second modified example, a flow rate of oxygen (O₂) supplied during the process of secondarily heat-treating the base structure may vary.

For example, when the base structure is secondarily heat-treated according to the second modified example, oxygen (O₂) may be supplied at a relatively low flow rate in an earlier stage at which oxygen (O₂) is supplied, while oxygen (O₂) may be supplied at a relatively high flow rate in a later stage. In other words, as an oxygen (O₂) supply time increases, a flow rate of oxygen (O₂) supplied may also be increased. For this reason, the oxygen vacancy may be easily eliminated from a center of the base structure as well as the surface of the base structure. Meanwhile, when oxygen (O₂) is supplied at a constant flow rate even when the oxygen (O₂) supply time increases, while the oxygen vacancy present on the surface of the base structure is easily eliminated, the oxygen vacancy present in the center of the base structure may not be eliminated.

### Method for Producing Negative Electrode Material for Lithium Secondary Battery According to Third Modified Example

Similar to the method for producing the negative electrode material for the lithium secondary battery according to the embodiment described above, a method for producing a negative electrode material for a lithium secondary battery according to a third modified example of the present invention may include: preparing a base structure including lithium-titanium-oxide (Li₄Ti₅O₁₂, LTO); improving an electric conductivity and a lithium ion conductivity of the base structure by primarily heat-treating the base structure; and eliminating an oxygen vacancy present in the primarily heat-treated base structure by secondarily heat-treating the primarily heat-treated base structure. However, the method for producing the negative electrode material for the lithium secondary battery according to the third modified example may have a different process of secondarily heat-treating the base structure as compared with the method for producing the negative electrode material for the lithium secondary battery according to the embodiment described above.

In detail, according to the method for producing the negative electrode material for the lithium secondary battery according to the embodiment described above, oxygen (O₂) may be supplied during the process of secondarily heat-treating the base structure. Meanwhile, according to the method for producing the negative electrode material for the lithium secondary battery according to the third modified example, oxygen (O₂) may be supplied during the process of secondarily heat-treating the base structure, and oxygen (O₂) may be continuously supplied even while the base structure is cooled to a room temperature after the secondary heat treatment is completed.

In addition, according to the method for producing the negative electrode material for the lithium secondary battery according to the third modified example, while oxygen (O₂) is supplied at a relatively low flow rate during the process of secondarily heat-treating the base structure, oxygen (O₂) may be supplied at a relatively high flow rate after the secondary heat treatment is completed. Accordingly, the oxygen vacancy present in the center of the base structure as well as the oxygen vacancy present in the surface of the base structure may be easily eliminated.

Meanwhile, when oxygen (O₂) is not continuously supplied after the secondary heat treatment is completed, an oxygen vacancy may be formed again in the base structure making contact with air. In addition, when a flow rate of oxygen (O₂) supplied during the secondary heat treatment and after the secondary heat treatment is completed is constant, the oxygen vacancy present in the center of the base structure may not be eliminated.

Accordingly, the methods for producing the negative electrode material for the lithium secondary battery according to the embodiment and the modified examples of the present invention have been described. Hereinafter, a specific experimental example and characteristic evaluation results of a negative electrode material for a lithium secondary battery according to an embodiment of the present invention will be described.

### Production of Negative Electrode Material for Lithium Secondary Battery According to Experimental Example

A lithium-titanium-oxide (Li₄Ti₅O₁₂, LTO) base structure was prepared. The base structure was placed in a muffle furnace and primarily heat-treated at a temperature of 780° C. (10° C./min ramping rate) for 5 hours in an air atmosphere. Thereafter, the primarily heat-treated base structure was placed in a tube furnace, and secondarily heat-treated at a temperature of 780° C. (10° C./min ramping rate) for 5 hours while supplying oxygen (O₂) at a flow rate of 0.5 L/min.

The base structure before the heat treatment will be defined as P-LTO, the base structure after the primary heat treatment will be defined as A-LTO, and the base structure after the secondary heat treatment will be defined as AO-LTO.

TABLE 1

| | |
|---|---|
| Li₄Ti₅O₁₂ before heat treatment | P-LTO |
| Primarily heat-treated Li₄Ti₅O₁₂ | A-LTO |
| Secondarily heat-treated Li₄Ti₅O₁₂ | AO-LTO |

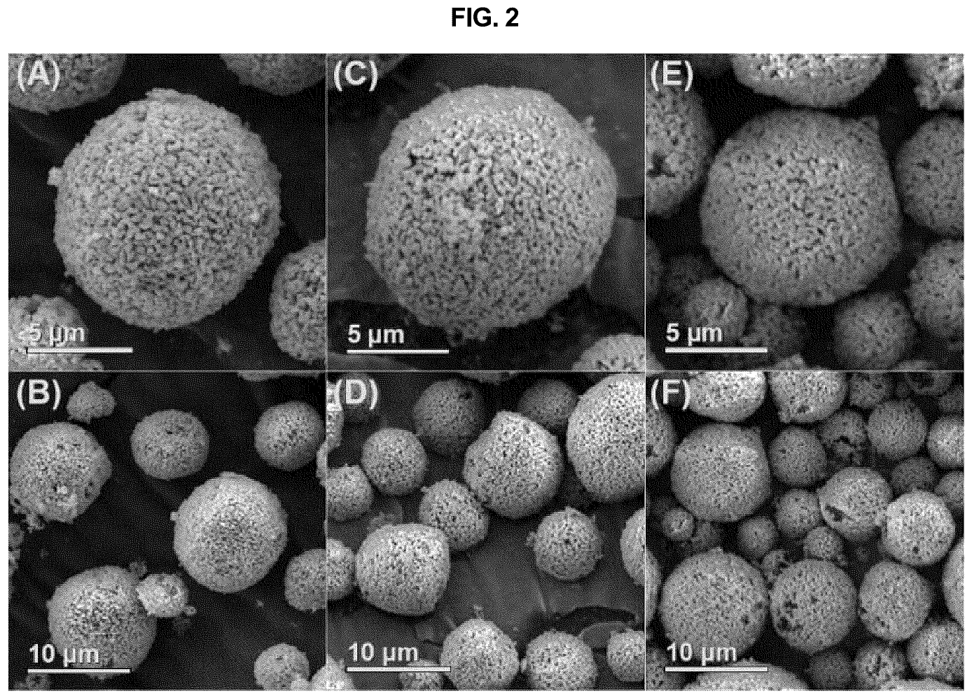

FIG. 2 is an SEM image of a negative electrode material for a lithium secondary battery according to an experimental example of the present invention.

Referring to FIG. 2, a scanning electron microscopy (SEM) image of the negative electrode material for the lithium secondary battery according to the experimental example is shown. In detail, (A) and (B) of FIG. 2 show SEM images of P-LTO, (C) and (D) of FIG. 2 show SEM images of A-LTO, and (E) and (F) of FIG. 2 show SEM images of AO-LTO.

As shown in (A) to (F) of FIG. 2, it was found that P-LTO, A-LTO, and AO-LTO had similar shapes and particle sizes. Accordingly, it may be found that the heat treatment process of P-LTO does not substantially cause variations in shape and particle size.

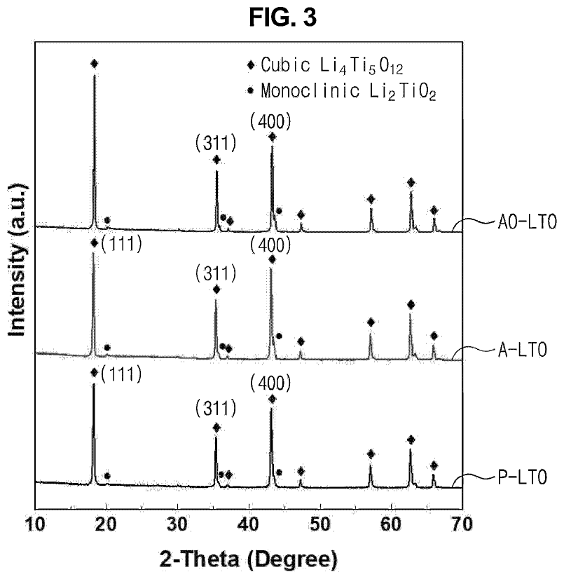

FIGS. 3 to 5 show XRD analysis results of the negative electrode material for the lithium secondary battery according to the experimental example of the present invention.

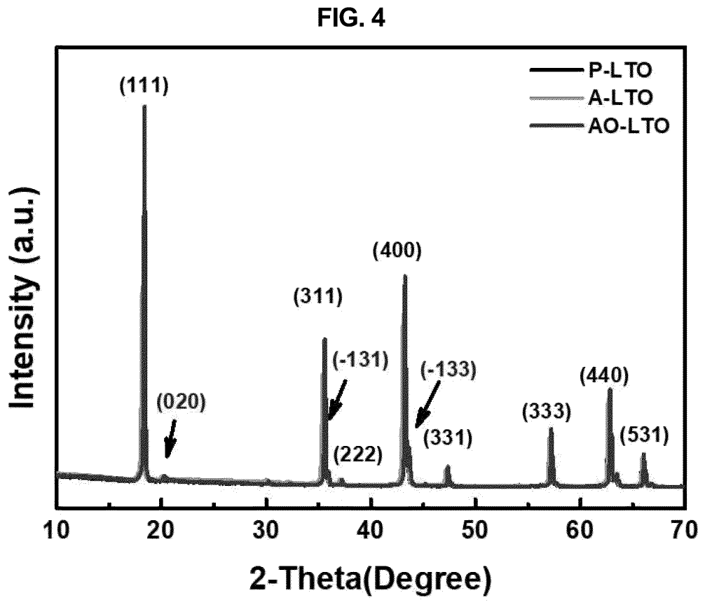

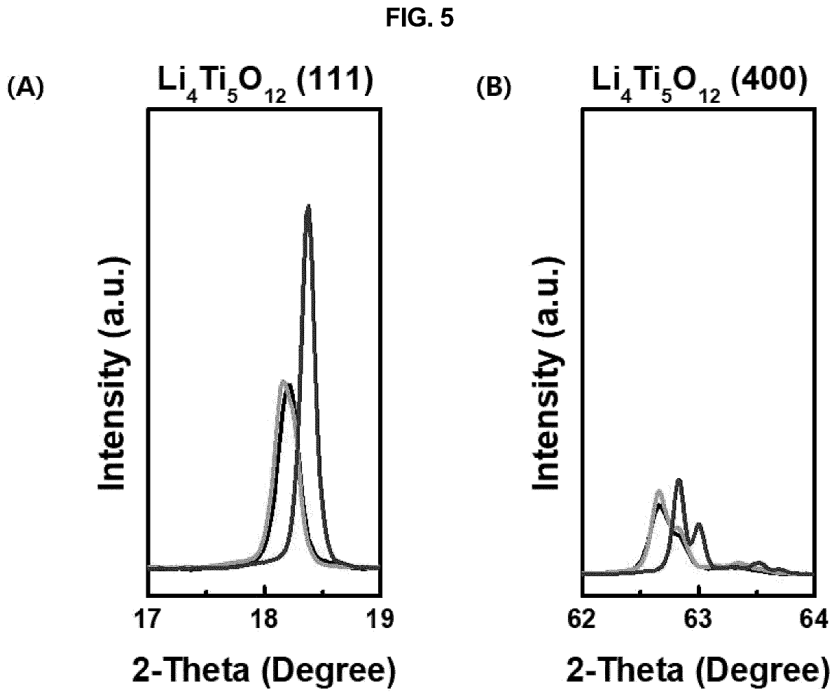

Referring to FIGS. 3 to 5, X-ray diffraction (XRD) analysis results of the negative electrode material for the lithium secondary battery according to the experimental example are shown. In detail, (A) of FIG. 5 is an enlarged view of a Li₄Ti₅O₁₂(111) peak in FIG. 4, and (B) of FIG. 5 is an enlarged view of a Li₄Ti₅O₁₂(400) peak in FIG. 4.

As shown in FIG. 3, it was found that cubic Li₄Ti₅O₁₂ and monoclinic Li₂TiO₂ appeared in all P-LTO, A-LTO, and AO-LTO. In addition, as shown in FIGS. 4 and 5, although there was no significant variation in composition, it was found that a peak shift occurred in AO-LTO as compared with P-LTO and A-LTO.

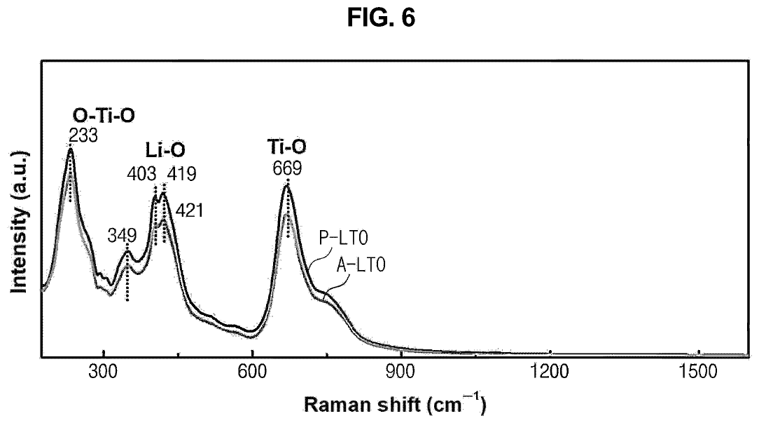

FIG. 6 shows a Raman analysis result of the negative electrode material for the lithium secondary battery according to the experimental example of the present invention.

Referring to FIG. 6, Raman analysis results for P-LTO and A-LTO are shown. As shown in FIG. 6, it was found that both P-LTO and A-LTO exhibit a spinel structure. In addition, although base lines of P-LTO and A-LTO match each other well, it was found that an intensity of a peak representing a connection between each metal and oxygen was slightly reduced.

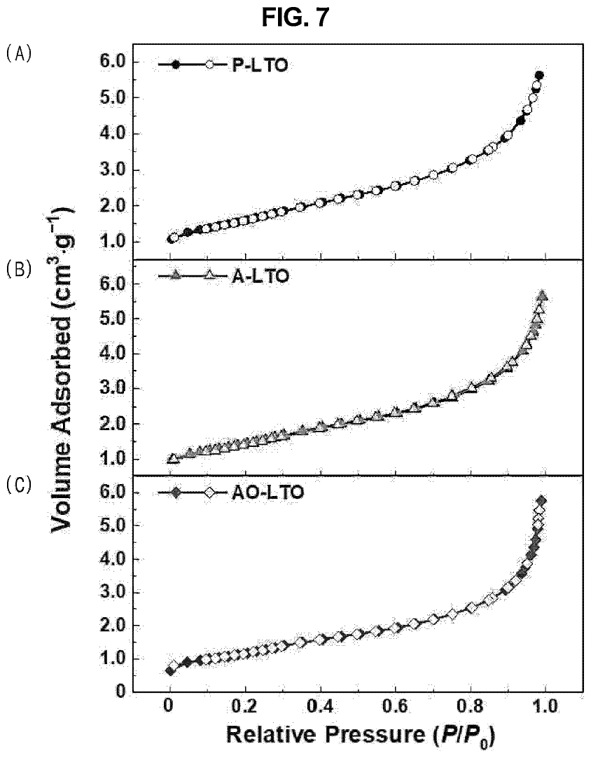

FIG. 7 is a view for describing a surface area of the negative electrode material for the lithium secondary battery according to the experimental example of the present invention.

Referring to FIG. 7, nitrogen adsorption/desorption (N₂ adsorption/desorption) was performed on each of P-LTO, A-LTO, and AO-LTO, to measure a BET surface area, a total pore volume, and a mean pore diameter. Measurement results are summarized in <Table 2> below.

TABLE 2

| Classification | P-LTO | A-LTO | AO-LTO |
|---|---|---|---|
| BET Surface Area (m²/g) | 5.70 | 5.03 | 4.46 |
| Total Pore Volume (cm³/g) | 0.0087 | 0.0086 | 0.0089 |
| Mean Pore Diameter (nm) | 6.12 | 6.85 | 7.99 |

As shown in FIG. 7 and <Table 2>, it was found that there was no significant difference in the BET surface area, the total pore volume, and the mean pore diameter of P-LTO, A-LTO, and AO-LTO.

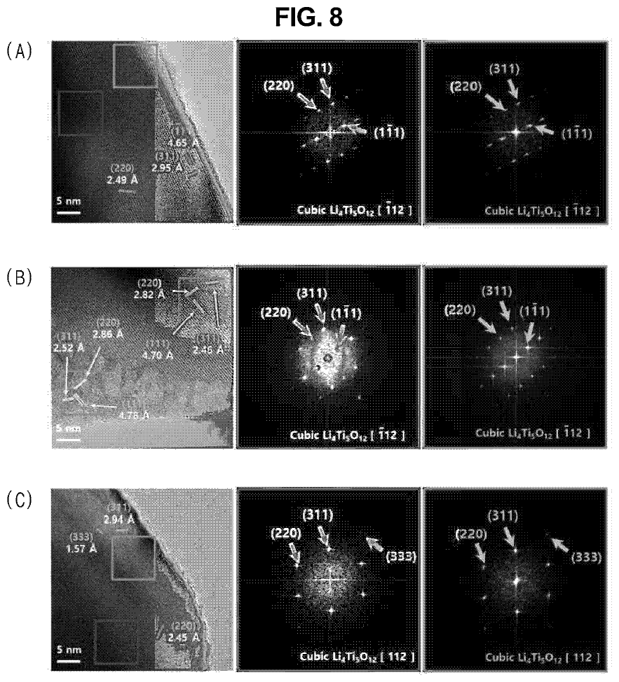

FIG. 8 is a TEM image of the negative electrode material for the lithium secondary battery according to the experimental example of the present invention.

Referring to (A) to (C) of FIG. 8, transmission electron microscope (TEM) images for P-LTO, A-LTO, and AO-LTO are shown. As shown in (A) to (C) of FIG. 8, it was found that an oxygen vacancy was distributed on a surface of A-LTO obtained by primarily heat-treating P-LTO. Meanwhile, in a case of AO-LTO obtained by the secondary heat treatment, it was found that oxygen vacancies present on the surface were eliminated, unlike A-LTO.

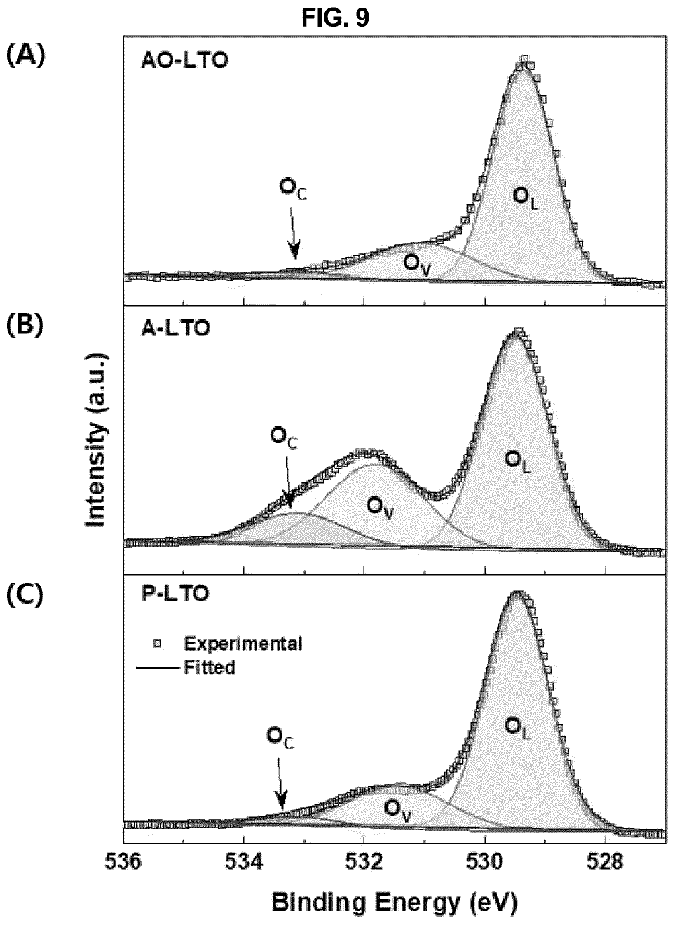

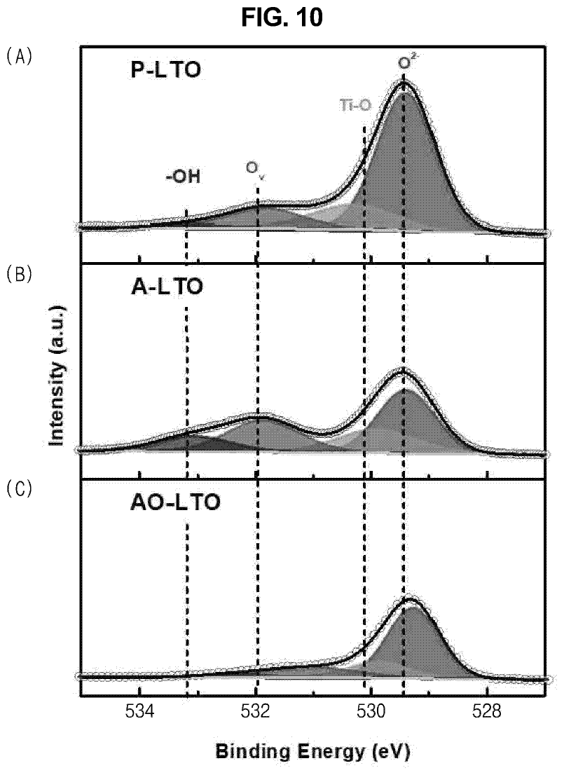

FIGS. 9 and 10 show XPS analysis results of the negative electrode material for the lithium secondary battery according to the experimental example of the present invention.

Referring to FIGS. 9 and 10, X-ray photoelectron spectroscopy (XPS) analysis results for P-LTO, A-LTO, and AO-LTO are shown. As shown in FIGS. 9 and 10, it was found that an oxygen vacancy Oᵥ of A-LTO obtained by primarily heat-treating P-LTO was significantly increased. Meanwhile, in the case of AO-LTO obtained by the secondary heat treatment, it was found that an oxygen vacancy was significantly reduced, unlike A-LTO. More specific results analyzed through FIGS. 9 and 10 are summarized in <Table 3> to <Table 5> below.

TABLE 3

| P-LTO | Peak Position | FWHM | Area | % Area |
|---|---|---|---|---|
| O²— | 529.39 | 1.16 | 21795.5 | 68.58 |
| Ti—O | 530.29 | 1.67 | 5284.8 | 16.63 |
| Oᵥ | 531.88 | 1.55 | 4117.2 | 12.96 |
| —OH | 533.23 | 1.34 | 582.3 | 1.83 |

TABLE 4

| A-LTO | Peak Position | FWHM | Area | % Area |
|---|---|---|---|---|
| O²— | 529.38 | 1.15 | 9929.4 | 40.41 |
| Ti—O | 529.88 | 1.58 | 5054.8 | 20.57 |
| Oᵥ | 531.84 | 1.48 | 6422.2 | 26.14 |
| —OH | 533.08 | 1.53 | 3162.4 | 12.87 |

TABLE 5

| AO-LTO | Peak Position | FWHM | Area | % Area |
|---|---|---|---|---|
| O²— | 529.27 | 1.00 | 7687.1 | 47.77 |
| Ti—O | 529.62 | 1.61 | 6117.9 | 38.02 |
| Oᵥ | 531.24 | 1.38 | 1509.8 | 9.38 |
| —OH | 532.26 | 1.79 | 776.9 | 4.83 |

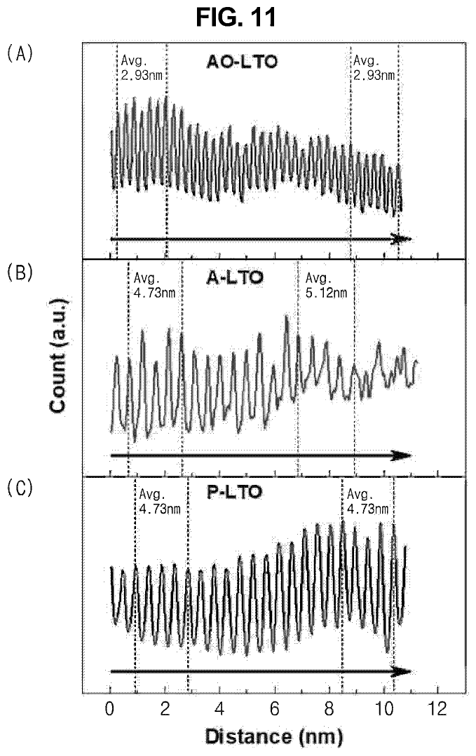

As shown in <Table 3> to <Table 5>, It was found that the oxygen vacancy was increased (12.96 area %→26.14 area %) when P-LTO was primarily heat-treated (A-LTO), while the oxygen vacancy was significantly reduced (26.14 area %→9.38 area %) by the secondary heat treatment (AO-LTO). In other words, it may be found that oxygen vacancies present in LTO are eliminated through the secondary heat treatment. FIG. 11 is a view for describing an inter-lattice distance of the negative electrode material for the lithium secondary battery according to the experimental example of the present invention.

Referring to (A) to (C) of FIG. 11, after P-LTO, A-LTO, and AO-LTO are prepared, an average inter-lattice distance (d-spacing) at a center (bulk) and an average inter-lattice distance at a surface for each of P-LTO, A-LTO, and AO-LTO were measured.

As shown in (C) of FIG. 11, in a case of P-LTO, it was found that the average inter-lattice distance at the center and the average inter-lattice distance at the surface were both 4.73 nm. Meanwhile, as shown in (B) of FIG. 11, in a case of A-LTO, it was found that the average inter-lattice distance at the center was 4.73 nm, while the average inter-lattice distance at the surface was 5.12 nm. Meanwhile, as shown in (C) of FIG. 11, in the case of AO-LTO, it was found that the average inter-lattice distance at the center and the average inter-lattice distance at the surface were both 2.93 nm.

### Production of Lithium Secondary Battery for Electrochemical Analysis Experiment

A slurry was prepared by mixing N-methyl-2-pyrrolidone with an active material, carbon black (Super-P), and a binder (polyvinylidene fluoride, PVDF) at a weight ratio of 8:1:1. P-LTO, A-LTO, and AO-LTO described above were used as the active material.

An electrode was prepared by doctor-blading the prepared slurry on a current collector (Cu foil). The prepared electrode was dried in a vacuum oven at 120° C. for 12 hours.

A CR 2032 type lithium secondary battery was produced by using lithium foil as a counter electrode, using a LiPF₆-based electrolyte, and using a Cegard 2320 membrane as a separation membrane. In more detail, a material obtained by mixing 1.0 M LiPF₆ with ethylene carbonate and ethyl methyl carbonate (EMC) at a volume ratio of 1:1 was used as the electrolyte.

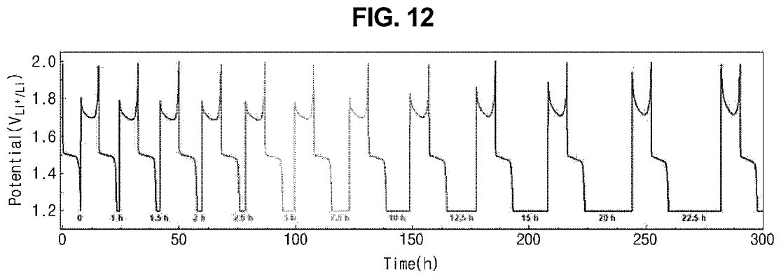

FIGS. 12 to 14 are views for describing galvanostatic charge/discharge analysis results of a lithium secondary battery according to an experimental example of the present invention.

Referring to FIGS. 12 to 14, galvanostatic charge/discharge analysis was performed to measure a memory effect of the lithium secondary battery according to the experimental example. In detail, the galvanostatic charge/discharge analysis was performed at a rate of 0.1 C (1 C=175 mAh/g) by using an automatic battery cycler (WBCS3000, WonATech).

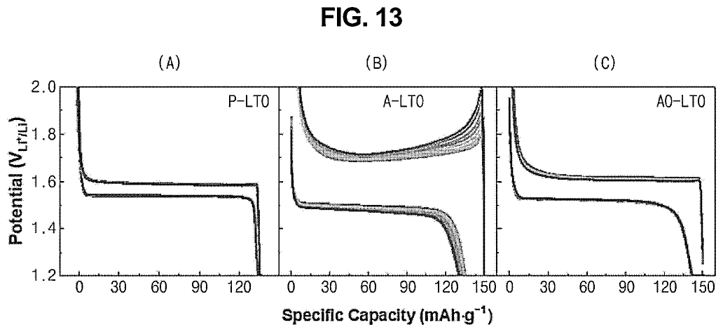

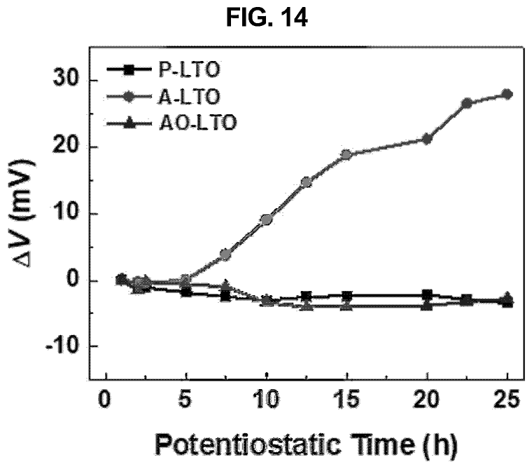

FIG. 12 shows electrochemical dependence on a potentiostatic time (tP) protocol used to record a memory effect. FIG. 13 shows voltage profiles of P-LTO, A-LTO, and AO-LTO at each tP. FIG. 14 shows a tP-dependent variation of the lowest point of a delithiation profile in a voltage profile without tP.

As shown in FIGS. 13 and 14, it was found that almost no memory effect occurs in the cases of P-LTO and AO-LTO, while a memory effect occurs significantly in the case of A-LTO.

Through the physical property analysis described above (SEM and TEM image analysis, XRD analysis, XPS analysis) and the results derived in FIGS. 12 to 14, it may be found that the memory effect occurring in A-LTO is caused by the oxygen vacancy, and the oxygen vacancy is caused by stagnated kinetics.

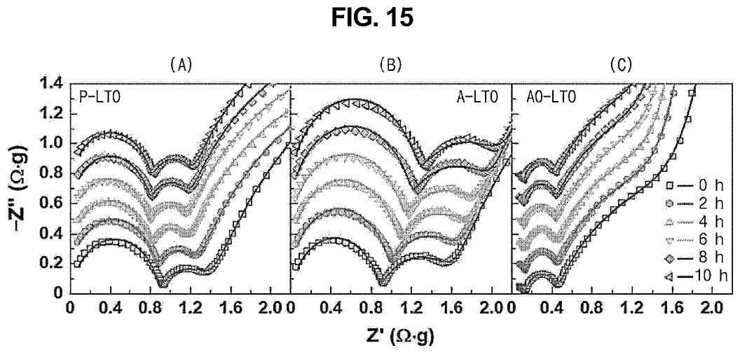

FIGS. 15 to 17 are views for describing EIS analysis results of the lithium secondary battery according to the experimental example of the present invention.

Referring to FIGS. 15 to 17, electrochemical impedance spectra (EIS) analysis of the lithium secondary battery according to the experimental example was performed. In detail, the EIS analysis was performed in a frequency range of 10⁶ to 10⁻² Hz by using a ZIVE BP2 potentiostat (WonATech).

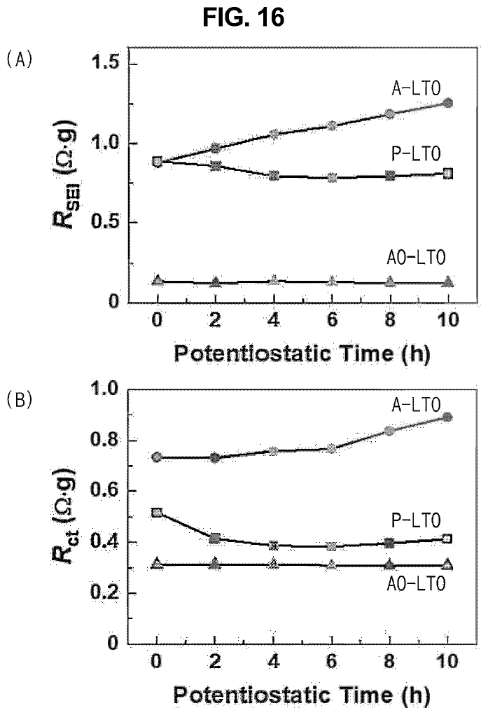

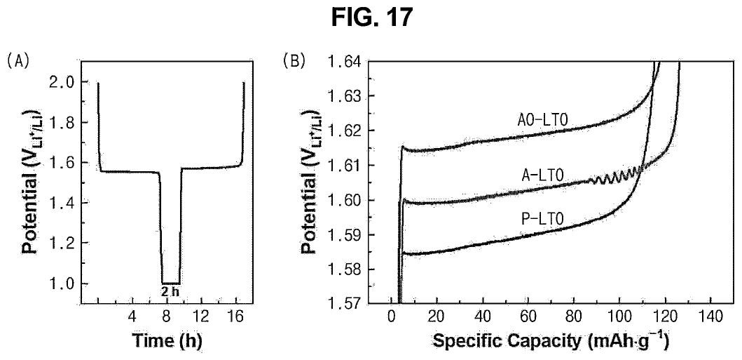

FIG. 15 shows Nyquist plots of P-LTO, A-LTO, and AO-LTO. FIG. 16 shows a variation in resistance R_{SEI} related to a charge movement through an SEI layer, and FIG. 17 shows a variation in resistance R_{ct} related to an interfacial charge movement.

As shown in FIG. 15, it was found that Nyquist spectra include a semi-circle portion and a tail portion. It was confirmed that in the cases of P-LTO and AO-LTO, shapes of the semi-circle portion and the tail portion are maintained substantially constant even when an analysis time increases (0 h→10 h), while in the case of A-LTO, both the shape of the semi-circle portion and the shape of the tail portion are changed as the analysis time increases (0 h→10 h).

As shown in FIGS. 16 and 17, it was found that in the cases of P-LTO and AO-LTO, an R_{SEI} value and an R_{ct} value were not increased, while in the case of A-LTO, the R_{SEI} value and the R_{ct} value were increased. Therefore, it may be found that the memory effect generated in A-LTO is a phenomenon caused by an interface layer formed similar to the SEI layer by a sample with increased reactivity due to introduction of the oxygen vacancy.

Although the exemplary embodiments of the present invention have been described in detail above, the scope of the present invention is not limited to a specific embodiment, and shall be interpreted by the appended claims. In addition, it is to be understood by those of ordinary skill in the art that various changes and modifications can be made without departing from the scope of the present invention.

### INDUSTRIAL APPLICABILITY

The negative electrode material for the lithium secondary battery according to the embodiment of the present invention may be applied to a lithium secondary battery.

1. A method for producing a negative electrode material for a lithium secondary battery, the method comprising:
preparing a base structure including lithium-titanium-oxide (Li₄Ti₅O₁₂, LTO);
improving an electric conductivity and a lithium ion conductivity of the base structure by primarily heat-treating the base structure; and
eliminating an oxygen vacancy present in the primarily heat-treated base structure by secondarily heat-treating the primarily heat-treated base structure.

2. The method of claim 1, wherein a primary heat treatment environment of the base structure and a secondary heat treatment environment of the base structure are different from each other.

3. The method of claim 2, wherein the primary heat treatment of the base structure is performed in an air atmosphere, and the secondary heat treatment of the base structure is performed in an oxygen (O₂) atmosphere.

4. The method of claim 1, wherein an oxygen vacancy content in the primarily heat-treated base structure is greater than an oxygen vacancy content in the base structure before the heat treatment, and
an oxygen vacancy content in the secondarily heat-treated base structure is less than the oxygen vacancy content in the base structure before the heat treatment.

5. The method of claim 1, wherein a primary heat treatment temperature and a primary heat treatment time of the base structure are identical to a secondary heat treatment temperature and a secondary heat treatment time of the base structure, respectively.

6. The method of claim 5, wherein the primary heat treatment and the secondary heat treatment of the base structure are performed at a temperature of 780° C. for 5 hours.

7. The method of claim 1, wherein an inter-lattice distance (d-spacing) of a surface of the base structure before the heat treatment is shorter than an inter-lattice distance of a surface of the primarily heat-treated base structure, and
an inter-lattice distance of a surface of the secondarily heat-treated base structure is shorter than the inter-lattice distance of the surface of the base structure before the heat treatment.

8. The method of claim 1, wherein the secondary heat treatment of the base structure is performed while supplying oxygen (O₂) at a flow rate of 0.5 L/min.

9. A negative electrode material for a lithium secondary battery, the negative electrode material comprising: 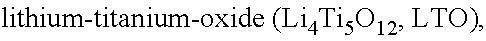
wherein, as a result of X-ray photoelectron spectroscopy (XPS) analysis of the lithium-titanium-oxide, an area ratio (area %) of an oxygen vacancy is less than or equal to 9.38%.

10. The negative electrode material of claim 9, wherein the lithium-titanium-oxide is not doped with a metal.

11. The negative electrode material of claim 10, wherein the metal includes aluminum (Al).

12. The negative electrode material of claim 9, wherein an average inter-lattice distance (d-spacing) of a center portion of the lithium-titanium-oxide is equal to an average inter-lattice distance of a surface portion of the lithium-titanium-oxide.
